(19) United States
(12) Patent Application Publication
(10) Pub. No.: US 2005/0075894 A1
(43) Pub. Date: Apr. 7, 2005

(54) System, method & software for a user responsive call center customer service delivery solution

(75) Inventors: Robert R. Bushey, Cedar Park, TX (US); Theodore B. Pasquale, Austin, TX (US); Elizabeth G. Gibson, Austin, TX (US); John M. Martin, Austin, TX (US); Benjamin A. Knott, Round Rock, TX (US); Kurt M. Joseph, Austin, TX (US)

Correspondence Address: BAKER BOTTS L.L.P.;PATENT DEPARTMENT, 98 SAN JACINTO BLVD., SUITE 1500, AUSTIN, TX, 78701-4039, US

(73) Assignee: SBC Knowledge Ventures, L.P., Reno, NV (US)

(21) Appl. No.: 10/679,214

(22) Filed: Oct. 3, 2003

(51) Int. Cl. G06F 17/60

(52) U.S. Cl. 705/1

(57) ABSTRACT

A system, method and software are provided for implementing an adaptive and dynamic call center customer service delivery solution. In operation, a user interface (U/I) model is selected from a library of U/I models as the U/I model likely to elicit favorable customer responses and to achieve customer completion of the selected transaction. The active U/I model may be re-evaluated at each node of the selected transaction and a new model selected in response to a determination that the active U/I model is no longer preferred. One or more U/I models may be updated based on observed user responsiveness, the efficiency of past transactions as well as on other grounds.

### TECHNICAL FIELD OF THE INVENTION

The present invention relates generally to call center technology and, more particularly, to a method, system and software for the provision of call center customer service.

### BACKGROUND OF THE INVENTION

Both consumers and organizations benefit from the use of automated call centers and information gathering. Setting aside the reduced costs an organization can pass along from reductions in overhead, a useful and functional automated information entry system can enable the consumer to avoid the all too common wait times associated with trying to resolve a matter with a large institution. In addition, a properly implemented call center can reduce customer misdirects, calls may be handled in less time and customer abandon rates may be reduced. Accordingly, a more effective and efficient call center system can be of great advantage to both an organization and the consumer public.

Today, many organizations choose a single customer call center system capable of producing acceptable results. While such systems often go through tweaks and upgrades after the system has an established working history and efficiency rating, they typically remain non-responsive to consumer preferences. As a result, many conventional call center systems are rigid, fail to take into consideration appropriate concerns and are seemingly artificially limited once deployed.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a schematic diagram depicting one embodiment of a telecommunications system incorporating teachings of the present invention;

FIG. 2 is a schematic diagram depicting an alternate embodiment of a telecommunications system incorporating teachings of the present invention;

FIG. 3 is a schematic diagram depicting a further embodiment of a telecommunications system incorporating teachings of the present invention;

FIG. 4 is a block diagram depicting an exemplary embodiment of a call center customer service delivery system incorporating teachings of the present invention; and

FIGS. 5 and 6 are flow diagrams depicting an exemplary embodiment of a method for implementing a user responsive call center customer service delivery solution incorporating teachings of the present invention.

### DETAILED DESCRIPTION OF THE INVENTION

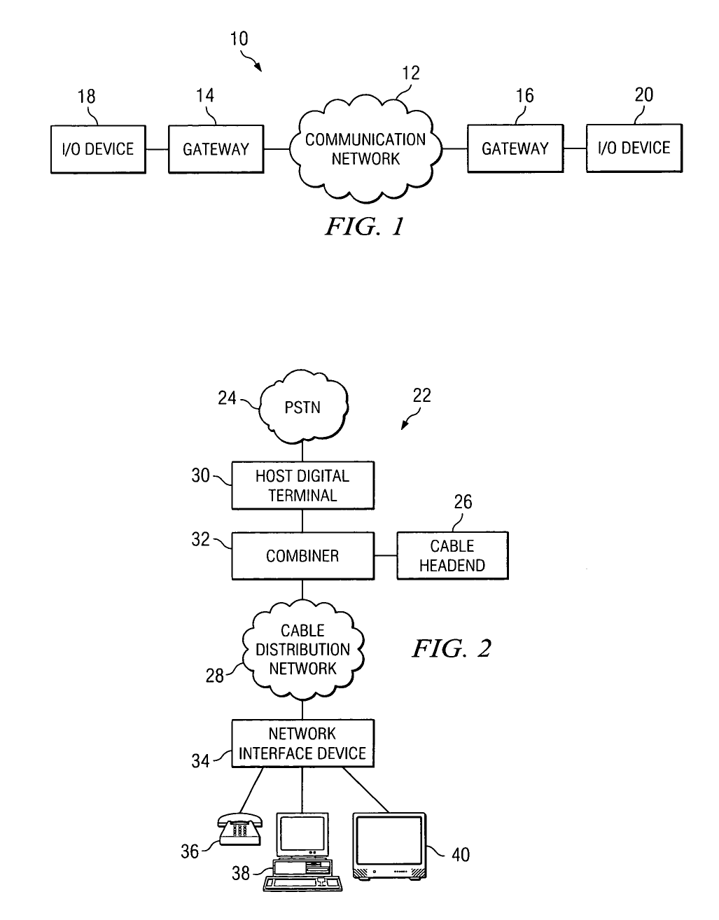

Preferred embodiments and their advantages are best understood by reference to FIGS. 1 through 6, wherein like numbers are used to indicate like and corresponding parts.

Referring first to FIG. 1, a schematic diagram of an exemplary embodiment of a telecommunications system, indicated generally at 10 is shown. Telecommunication system 10 may include communication network 12 in communication with one or more gateway devices 14 and 16. Input/output (I/O) devices 18 and 20 are each preferably in communication with respective gateway devices 14 and 16. Accordingly, I/O devices 18 and 20 may be in selective communication with each other via gateway devices 14 and 16, and communication network 12.

In one embodiment, communication network 12 may be a public switched telephone network (PSTN). In alternate embodiments, communication network 12 may include a cable telephony network, an IP (Internet Protocol) telephony network, a wireless network, a hybrid Cable/PSTN network, a hybrid IP/PSTN network, a hybrid wireless/PSTN network or any other suitable communication network or combination of communication networks.

Gateways 14 and 16 preferably provide I/O devices 18 and 20 with an entrance to communication network 12 and may include software and hardware components to manage traffic entering and exiting communication network 12 and conversion between the communication protocols used by I/O devices 18 and 20 and communication network 12. In some embodiments, gateways 14 and 16 may function as a proxy server and a firewall server for I/O devices 18 and 20. In some embodiments, gateways 14 and 16 may be associated with a router (not expressly shown), operable to direct a given packet of data that arrives at gateway 14 or 16, and a switch (not expressly shown), operable to provide a communication path in and out of gateway 14 or 16.

In the present embodiment, I/O devices 18 and 20 may include a variety of forms of equipment connected to communication network 12 and accessible to a user. I/O devices 18 and 20 may be telephones (wireline or wireless), dial-up modems, cable modems, DSL (digital subscriber line) modems, phone sets, fax equipment, answering machines, set-top boxes, televisions, POS (point-of-sale) equipment, PBX (private branch exchange) systems, personal computers, laptop computers, personal digital assistants (PDAs), SDRs, other nascent technologies, or any other appropriate type or combination of communication equipment available to a user. I/O devices 18 and 20 may be equipped for connectivity to communication network 12 via a PSTN, DSLs, a cable network, a wireless network, or any other appropriate communications channel.

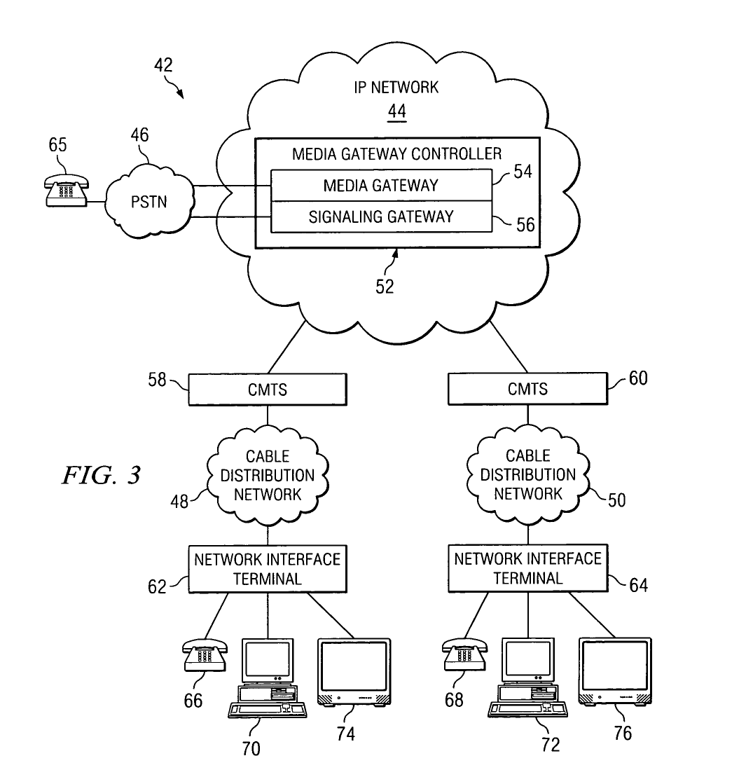

Referring now to FIG. 2, a block diagram of an exemplary embodiment of a telecommunication system 22 is shown. In the exemplary embodiment shown, system 22 preferably includes a PSTN 24 and cable head-end 26 in communication with cable distribution network 28. PSTN 24 may be in operable communication with host digital terminal (HDT) 30 and function to convert signals received from PSTN 24 for transmission over cable networks. Host digital terminal 30 and cable head-end 26 may be in communication with combiner 32. Combiner 32 may communicate data received from cable head-end 26 and/or PSTN 24 to cable distribution network 28. Cable distribution network 28 may further communicate data to network interface device 34 to a user via telephone 36, computer 38, television 40 or any other suitable I/O device. Cable head-end 26 may provide cable television programming and cable modem communications. Cable head-end 26 typically includes a cable modem termination system (not expressly shown) for sending and receiving digital cable modem signals.

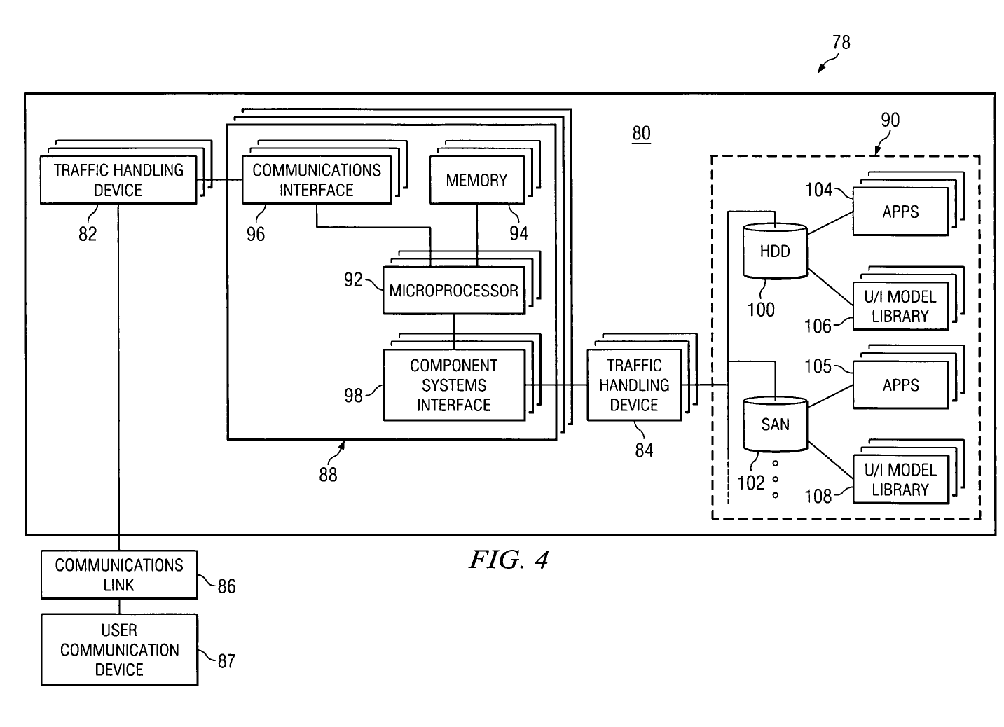

Referring next to FIG. 3, a block diagram of an exemplary embodiment of a telecommunication system 42 is shown. This exemplary embodiment generally includes interconnected IP network 44, PSTN 46, and cable distribution networks 48 and 50. IP network 44 may include media gateway controller 52, media gateway 54, and signaling gateway 56. Media gateway 54 and signaling gateway 56 may be in operative communication with PSTN 46 and facilitate communication of information therebetween. IP network 44 may further communicate with cable distribution networks 48 and 50 via cable modem termination systems (CMTS) 58 and 60, respectively. CMTS 58 and 60 may convert IP packets received from IP Network 44 for transmission on cable distribution networks 48 and 50 and convert signals received from cable distribution networks 48 and 50 into IP Packets for transmission to IP Network 44. Cable distribution networks 48 and 50 may communicate information with users via network interface terminals 62 and 64. Network interface terminals 62 and 64 may provide data services to users through I/O devices such as, telephones 66 and 68, computers 70 and 72, and televisions 74 and 76. One or more data services may also be provided to a user through PSTN 46 and one or more I/O devices such as telephone 65.

Telecommunication system 42 of FIG. 3 preferably allows transmission of services to be delivered to users where such services include, without limitation, voice over Internet protocol (“VoIP”), video over Internet, video-on-demand over broadband connections, and the ability to view television and film images as well as broadcasts. In addition, one of ordinary skill will appreciate that other embodiments can be deployed with many variations in the number and type of I/O devices, communication networks, the communication protocols, system topologies, and myriad other details without departing from the spirit and scope of the present invention.

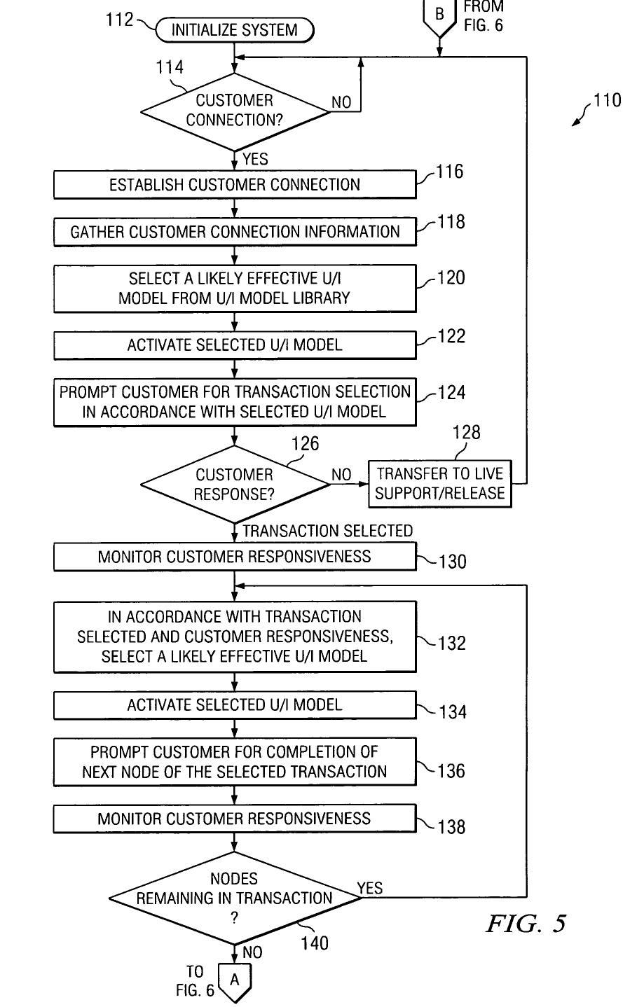

Referring now to FIG. 4, an exemplary embodiment of a call center customer service delivery system incorporating teachings of the present invention and operable to provide user responsive customer service to call center patrons is shown. As depicted in FIG. 4, system 78 preferably includes at least one adaptive call center customer service delivery solution system 80.

System 80 of FIG. 4 preferably enables a purveyor of a customer service call center, for example, to achieve, among other benefits, greater numbers of favorable responses to system prompts and completed transactions by adapting the manner in which a call center system user interface (U/I) guides a consumer through one or more desired transactions based on monitored characteristics of the user's responsiveness to various U/I prompts. In one embodiment, adaptive call center customer service delivery solution system 80 may include one or more traffic handling devices 82 and 84. Traffic handling devices 82 and 84 may include, but are not limited to, such devices as routers, switches, hubs, bridges, content accelerators, or other similar devices. As depicted, one or more traffic handling devices 82 may be coupled between communications link 86 and computer system 88.

In an embodiment of adaptive call center customer service delivery solution system 80 having a component or storage system 90 which is maintained separately from computer system 88, as depicted in FIG. 4, one or more traffic handling devices 84 may also be included and coupled between computer system 88 and storage system 90. As described below, storage system 90 or portions thereof may be incorporated into computer system 88, according to teachings of the present invention.

Computer system 88 may be constructed according to a variety of configurations. Preferably, however, computer system 88 includes one or more processors or microprocessors 92. Processors or microprocessors 92 may include such computer processing devices as those manufactured by Intel, Advanced Micro Devices, Motorola, Transmeta, as well as others. Operably coupled to microprocessor(s) 92 are one or more memory devices 94. Memory devices 94 may include, but are not limited to, such memory devices as SDRAM (synchronous dynamic random access memory), RDRAM (Rambus dynamic random access memory), FLASH memory, or other memory device operable to functioning with the microprocessor(s) 92 of choice.

Also operably coupled to microprocessor(s) 92 are one or more communications interfaces 96. Communications interface 96 may employ wire-line and/or wireless technologies. For example, wire-line based communications interfaces 96 may include, but are not limited to, such wire-line technologies as PSTN (public switched telephone networks), Ethernet, Token-Ring, coaxial, fiber optic, as well as others. Examples of wireless technology based communications interfaces 96 may include, but are not limited to, such wireless technologies as Bluetooth and IEEE (Institute of Electrical and Electronic Engineers) 802.11b, CDMA (code division multiple access), TDMA (time division multiple access), PCS (personal communication system), paging, GSM (global system for mobile communications), as well as others.

One or more component systems interfaces 98 are also preferably included and coupled to microprocessor 92. According to teachings of the present invention, component systems interfaces 98 preferably couple one or more component systems to microprocessor(s) 92 such that microprocessor(s) 92 may access one or more aspects of functionality included therein. Examples of component systems include storage system 90, video displays, storage devices, scanners, CD-ROM (compact-disc-read only memory) systems, input/output devices, etc. Component systems interfaces 98 may include, for example, ISA (industry standard architecture) connections, PCI (peripheral component interconnect) connections, PCI-X (peripheral component interconnect-extended) connections, SCSI (small computer systems interface) connections, USB (universal serial bus) connections, FC-AL (fibre-channel arbitrated loop) connections, serial connections, parallel connections, Ethernet connections, IEEE 802.11b receivers/transmitters, Bluetooth receivers/transmitters, as well as others. In addition, component systems interfaces 98 may be provided to couple one or more components system internal to computer system 88, such as hard disc drive (HDD) devices, CD-ROM read/write devices, etc., to microprocessor(s) 92.

As illustrated in FIG. 4 and as mentioned above, one or more traffic handling devices 84 may be coupled between computer system 88 and storage system 90. In an alternate embodiment, however, storage system 90 may be included within or internal to computer system 88. In such an embodiment, storage system 90 or one or more components thereof may be directly coupled to the one or more component systems interfaces 98.

Component or storage system 90 may include a variety of computing devices and is preferably not limited to one or more types of storage device. In the embodiment of storage system 90 illustrated in FIG. 4, a plurality of storage devices, preferably storing one or more applications and databases for use in accordance with teachings of the present invention, may be provided. Specifically, component or storage system 90 may include one or more hard disc drive (HDD) devices 100, digital linear tape (DLT) libraries (not expressly shown), CD-ROM libraries and/or one or more storage area networks (SAN) 102. In yet another embodiment of adaptive call center customer service delivery system 80, one or more HDD devices 100 may be included in computer system 88 with one or more SANs 102 included in storage system 90.

As with many computer systems, a variety of applications 104 and 105 may be used to leverage the functionality or processing capability of computer system 88. In the present invention, a plurality of applications 104 and 105, including one or more aspects of the operations of the present invention, may be effectively included in storage system 90, on one or more HDD devices 100 and/or on one or more SANs 102. For example, one or more communications applications operable to establish a communication connection with one or more users or customers via communication link 86 may be included in storage system 90. In addition, one or more speech recognition or voice analysis applications may be included on HDD devices 100 and/or SAN 102 for use as described below. A variety of additional applications 104 and 105 may also be included on one or more of HDD devices 100 and/or SANs 102.

As will be described in more detail below with respect to an embodiment of a method incorporating teachings of the present invention, one or more U/I model libraries 106 and 108 are preferably included on storage system 90. U/I model libraries 106 and 108 preferably include a plurality of adaptive call center customer service delivery solution system U/I models, one or more of which may be selected for use during a transaction with a call center customer or user.

In one embodiment, the U/I models stored in U/I model libraries 106 and 108 may be pre-defined, e.g., a complete U/I model or one having a defined gender, rate of speech, system prompt menu, etc., needing only to be selected and activated for use in adaptive call center customer service delivery solution system 80. Each U/I model in U/I model libraries 106 and 108 may also include a number of styles or strategies. For example, within a U/I model designed to communicate like a calm, caring, mature female (e.g., a motherly persona), the U/I model library may include a first subset of prompts or scripted dialog designed to help novice callers, a second subset designed to help expert callers, a third subset designed to sound sympathetic and soothing and a fourth subset designed to be more abrupt. These different subsets or styles may be produced by altering characteristics of the U/I model, such as speaking rate, choice of formal or informal words, use of terse or verbose utterances, etc.

As discussed below, adaptive call center customer service delivery solution system 80 may dynamically change from one U/I model to another in response to one or more tracked or monitored characteristics of a caller connection as well as one or more characteristics of the caller's responsiveness to the active U/I model. In addition, one or more aspects of a U/I model may be adapted to respond to one or more perceived characteristics of the current user, one or more perceived user difficulties with a U/I model prompt, etc. A U/I model may be altered in real-time, during a transaction or following completion of a transaction and an evaluation of its efficacy.

U/I model libraries 106 and 108 may also contain a plurality of adaptive call center customer service delivery solution system U/I model components, such as gender, rate of speech, tone, inflection, prompt menus, etc. An adaptive call center customer service delivery solution system U/I model may be selected and compiled from available U/I model components to create a U/I model which has been determined, according to teachings of the present invention, to be a U/I model likely to elicit favorable responses from the user, encourage the user to complete their selected transaction, as well as to achieve other benefits.

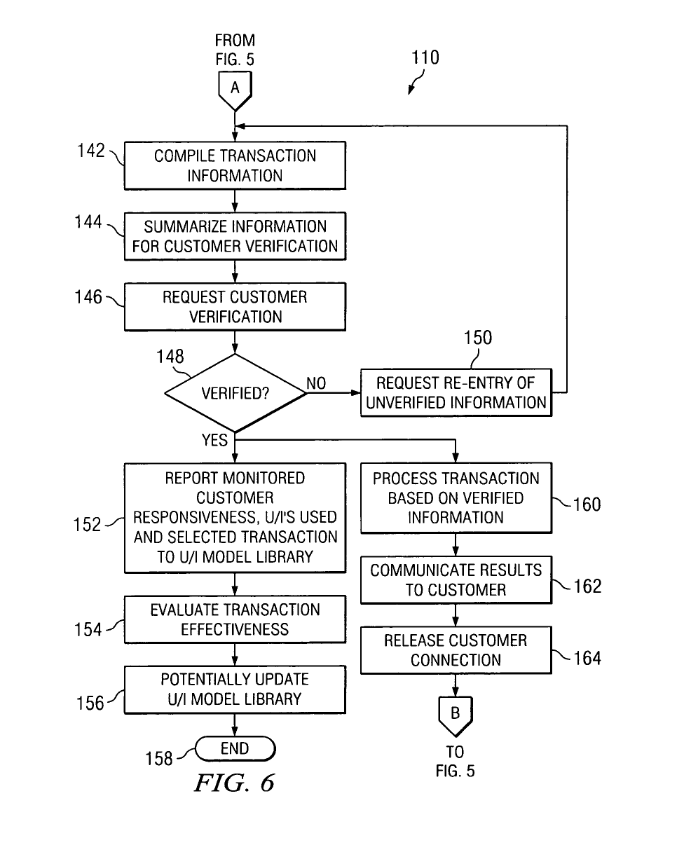

Referring now to FIGS. 5 and 6, flow diagrams illustrating an exemplary embodiment of a method for provisioning user support in a call center environment are shown. In a preferred embodiment, method 110 preferably provides an adaptive, dynamic, consumer responsive call center customer service delivery solution. Also in a preferred embodiment, method 110 may be executed by a computer system, such as adaptive call center customer service delivery solution system 80 or another effectively enabled computer system. Method 110 may also be implemented as a program of instructions storable in a memory and executable by a processor. The program of instructions may be disposed on a floppy disk, a CD-ROM, Magnetic Tape or other comparable storage medium.

In one aspect, a call center customer service delivery solution methodology incorporating teachings of the present invention enables effective and efficient automated information entry and information gathering. A call center customer service delivery solution methodology incorporating teachings of the present invention is adaptive, dynamic and consumer responsive in a variety of respects. First, a customer service delivery methodology incorporating teachings of the present invention may be adapted, real-time or otherwise, based on one or more success factors defined by the employer of the methodology. Second, U/I models employed by a method incorporating teachings of the present invention are preferably adaptive and dynamic in that the U/I models may be altered in response to observed user behavior or customer interaction therewith as well as in response to performance metrics associated with transaction completions, efficiency rates, etc. Third, a method incorporating teachings of the present invention is adaptive and dynamic in that during customer or user interaction is repeatedly evaluated based on one or more variables that together determine the appropriate U/I model to be employed at any given time during a transaction. Additional characteristics, traits and advantages of teachings of the present invention may be appreciated in light of the present disclosure.

Upon initialization at 112, method 110 preferably proceeds to 114. At 114, adaptive call center customer service delivery system 80 and method 110 preferably await a customer or user connection, such as a customer or user communication connection via user communication device 87, telephones 36, 65, 66 and 68, computers 38, 70 and 72, televisions 40, 74 and 76, I/O devices 18 and 20, as well as other customer communication connection or I/O devices. If no customer communication connection is detected at 114, method 110 preferably loops and remains in a wait state at 114 for one or more consumer or customer communication connections. If at 114 a customer communication is detected, method 110 preferably proceeds to 116 where a customer connection between a customer's communication or I/O device and adaptive call center customer service delivery system 80 may be established.

Once a communication connection has been established at 116, method 110 may provide for the automated collection or gathering of information on one or more aspects of the customer communication connection at 118. At 118, one or more aspects of adaptive call center customer service delivery system 80 may be employed to gather characteristics of customer connection established at 116. For example, adaptive call center customer service delivery system 80 may be configured with ANI, caller-ID, or other capabilities operable to determine the telephone number from which the current customer communication connection originated. In an alternate embodiment, adaptive call center customer service delivery system 80 may be operable to determine the customer's IP address, MAC (media access control) address, etc., in instances where a customer connects via a computer or similar communication connection. Additional information, which may be useful in selecting a U/I model likely to enable a calling customer to complete a selected transaction, according to teachings of the present invention, includes, but is not limited to, time of day of the customer connection, telephone number or URL (uniform resource location) to which the customer connected, geographic region from which the customer connection originated or to which the customer connection was linked, type of U/I for the I/O device used by the customer, season of call and communication network (PSTN, IP, CDMA, TDMA, etc.) on which the customer has been connected. Once one or more customer connection information characteristics or aspects have been gathered at 118, method 110 preferably proceeds to 120.

At 120, selection of a first or initial U/I model from one or more libraries of user interface models 106 and 108 included on adaptive call center customer service delivery system 80 is preferably performed. Selection of a first or initial U/I model from library of user interface model 106 or 108 may be based on a variety of variables or characteristics. For example, selection of the first or initial U/I model from library of user interface models 106 or 108 on adaptive call center customer service delivery system 80 may be based on the telephone number or IP address from which the current customer connection originated. In a further example, selection of the U/I model from U/I model library 106 and 108 may be based on the geographic region from which the customer communication connection originated, the time of day the customer connection was established with adaptive call center customer service delivery system 80, the contact number with which the customer connection was established at adaptive call center customer service delivery system 80, as well as based on other characteristics of a given customer connection. In an alternate embodiment, selection of a first or initial U/I model may be from a limited list of one or more “default” initial U/I models. Upon selection of the first or initial U/I model from user interface model libraries 106 and 108 at 120, method 110 preferably proceeds to 122 where the first or initial user interface model is preferably activated for service.

Once the first or initial selected U/I model is activated at 122, the caller or customer is preferably prompted for selection of a transaction in accordance with the selected or active U/I model at 124. Prompting a caller or customer in accordance with the active U/I model may be performed using a variety of methodologies and may possess a variety of traits. For example, prompting a caller or customer in accordance with the active U/I model may result in a prompt requesting that the customer select a transaction or perform an operation via touch-tone buttons on a touch-tone telephone. In an alternate U/I model, the caller or customer may be prompted to select a transaction using the caller's or customer's own voice. In still further embodiments, the selected user interface model may request that the caller or customer select a transaction or perform an operation through the customer's computer, the customer's television or other customer I/O device.

In a preferred embodiment, prompting of a user or customer preferably includes motivational language. For example, to convince a user to select a transaction rather than wait on live support, the U/I model may be configured to advise the user of benefits flowing from using the automated system, e.g., “To reduce your wait time by at least ten minutes, please select a transaction from the following options”.

Once the customer has been prompted for selection of a transaction in accordance with the first or initial selected U/I model at 124, method 110 preferably proceeds to 126 where a customer response is preferably awaited. If after a predetermined time no customer response or transaction selection is detected, method 110 preferably proceeds the 128 where the customer or caller may be transferred to a live representative, the customer communication connection released or the customer may be otherwise served. If the caller or customer is transferred to live support, released or otherwise served at 128, method 110 preferably returns to 114 where a subsequent customer connection may be awaited. Alternatively, if at 126 a customer transaction selection is detected, method 110 preferably proceeds to 130.

At 130, one or more aspects of user or customer responsiveness to the prompt for transaction selection at 124 are preferably tracked and/or monitored. For example, if at 124 the user or customer was prompted for transaction selection and presented with transaction selection via touch-tone responses or voice responses, the method by which the user or customer selected their transaction may be monitored at 130, e.g., monitoring whether the user selects a transaction via touch-tone or voice response. Other aspects of user or customer transaction selection which may be monitored include, without limitation, time between prompting of the user for transaction selection and user response to the transaction selection prompt, inflection in customer's voice response, such as via one or more voice analysis applications included in application databases 104 and 105, speed with which user or customer voice transaction selection was uttered, and speed with which the user entered a touch-tone transaction selection. Additional aspects, characteristics or other traits of user or customer responsiveness may be tracked and/or monitored at 130 without departing from the spirit and scope of the present invention.

At 132, selection of a U/I model from one or more user interface model libraries is preferably repeated in an effort to predict or maintain for presentation to a user or customer the U/I model most likely to elicit favorable responses from the user or customer in completing the user or customer selected transaction. Selection or prediction of a new or alternate U/I model at 132 may be motivated by a variety of parameters or variables. For example, in addition to considering time of day, geographic region from which customer connection originated, means by which customer connection is established, etc., selection of a new or alternate U/I model at 132 may consider one or more aspects of customer responsiveness monitored at 130. As mentioned above, for example, if at 124 the user was presented with the transaction selection options of touch-tone button responses or voice responses, method 110 at 132 may take into account in its new or alternate U/I model selection whether the user or customer selected a transaction via touch-tone button or voice response. Method 110, at 132, may also take into account other aspects of the user or customer's responsiveness monitored at 130 such as one or more characteristics reflective on user or customer familiarity with adaptive call center customer service delivery system 80 transaction processes. One or more system defined metrics may also be employed by Method 110 is predicting or selecting a U/I model for presentation to a user. Once a new or alternate U/I model has been selected at 132, method 110 preferably proceeds to 134 where the new or alternate U/I model may be activated.

It should be noted that selection of a new or alternate U/I model may yield selection of a U/I model currently in use or previously used in performance of the instant transaction. A goal of U/I model reselection at 132 is to ensure the active U/I model is the U/I model most likely to elicit favorable responses from the user, to encourage user completion of their selected transaction and to minimize user and system errors in the process.

Once a new or alternate U/I model has been activated at 134, the user or customer may be prompted for completion of the next node of the user or customer selected transaction in accordance with the active or current U/I model at 136. As mentioned above, prompting a user or customer in accordance with the active U/I model may be achieved using a variety of methodologies. As mentioned above, prompting in accordance with the current or active U/I model preferably incorporates motivating the user to comply with instructions of the active U/I model and may also include such assurances as that any information provided by the user will be maintained in confidence. Alternate forms of prompting in accordance with teachings of the present invention may be utilized without departing from its spirit and scope.

Upon prompting the customer or user for completion of the next node of the user or customer's selected transaction at 136, method 110 preferably proceeds to 138 where one or more aspects or characteristics of user or customer responsiveness to the prompt generated in accordance with the active U/I may be monitored. Proximate the performance of the operations indicated at 136 and 138 of method 110, one embodiment of the present invention may include additional operations similar to those discussed above with reference to operations 126 and 128. For example, if after prompting the user or customer for completion of the next node of the selected transaction at 136, no user or customer response is detected, the user or customer may be transferred to a live representative, the current customer connection may be released or the user or customer may be otherwise serviced.

At 140 of method 110, adaptive call center customer service delivery system 80 preferably determines whether there are any remaining nodes in the customer selected transaction to be completed for the requirements of the selected transaction to be fulfilled. If the user or customer selected transaction requires completion of additional nodes, method 110 preferably returns to 132 where the selection of a U/I model predicted to elicit effective user or customer responsiveness in completing the customer selected transaction may be repeated. By incorporating such capabilities, method 110 may adapt and dynamically respond to changes in customer disposition, responsiveness, etc. Alternatively, if it is determined at 140 that the user has provided all information required by the user or customer selected transaction, method 110 preferably proceeds to 142 of FIG. 6.

It is contemplated within the spirit and scope of the present invention that repetition of the operations indicated at 132 of method 110 may generate repeated selection of the same U/I model, as well as selection of a wide variety of U/I models in completing the user or customer selected transaction.

At 142, information gathered from the customer communication connection, information provided by the user or customer as a result of U/I model prompts through the various nodes of the selected transaction, as well as other information are preferably compiled. Once the relevant or selected transaction information has been compiled or collected at 142, method 110 preferably proceeds to 144 where the selected or relevant information may be summarized and presented to the user for verification.

At 146, upon presentation of the summary information at 144, the customer may be prompted for verification of one or more aspects of the transaction information compiled at 142. At 148, user verification is preferably awaited.

If at 148 the user identifies one or more aspects of incorrect information, method 110 preferably proceeds to 150 where re-entry of the unverified or incorrect information may be requested. Upon entry of corrected information for the unverified or incorrect information, method 110 preferably returns to 142 where the compilation of transaction information may be performed and followed by a new summary of information at 144 and a new request for customer verification at 146. Once verification of the summary information at 148 has completed, method 110 may begin the operations indicated generally at 152 and 160 of method 110. In alternate embodiments, information elicited from a user may be summarized and/or verified following completion of each or a single node of the selected transaction, in response to customer provision of a complex information entry operation, as well as at other stages of method 110 and/or the user selected transaction.

The operations indicated at 152, 154, 156 and 158 preferably enable method 110 to provide an adaptive and dynamic information gathering system that is responsive to user or customer preferences, habits, traits, etc. A U/I model update system or application may be included on adaptive call center customer service delivery system 80 as an application available in application libraries 104 or 105. In an alternate embodiment, a U/I model update system or application may be implemented separate and apart from, but in operable communication with, adaptive call center customer service delivery system 80. At 152, one or more of the various aspects of customer responsiveness monitored throughout processing of the customer selected transaction are preferably reported to U/I model libraries 106 and/or 108.

At 154, method 110 preferably provides for the effectiveness of completion of the selected transaction to be evaluated. Evaluation of transaction effectiveness may take into account a variety of the monitored customer responsiveness characteristics, the various U/I models employed, the customer selected transaction as well as a number of other characteristics or aspects of transaction completion process.

Depending upon the transaction effectiveness evaluation at 154, the monitored customer responsiveness, the U/I models used, the selected transaction, and/or other characteristics of the performance of the customer selected transaction, one or more components of U/I model libraries 106 and/or 108 may potentially be updated at 156. For example, if adaptive call center customer delivery system 80, after processing a certain number of similar transactions, determines that a majority of users or customers prefer touch-tone information entry over voice information entry, one or more U/I models which employ customer prompting of information entry using both touch-tone entry and voice entry may be modified to reflect the observed customer preferences for touch-tone entries. Alternative implementations of making U/I model libraries 106 and 108 adaptive and/or dynamic in response to observed results are contemplated within the spirit and scope of the present invention. For example, for a more adaptive and dynamic U/I model library, operations 152, 154 and 156 may be performed following the completion of a first node of the selected transaction. The U/I model library update portion of the method 110 may then end at 158.

The operations indicated generally at 160, 162 and 164 at method 110 may be included to facilitate conventional transaction completion. At 160, information gathered from the user or customer in light of the selected transaction is preferably processed to generate a transaction result. At 162, the one or more results of the selected transaction are preferably communicated to the user. Upon communication of the selected transaction results to the user or customer at 162, method 110 preferably proceeds to 164 where the user communication connection may be released. Upon release of the current user or customer communication connection at 164, method 110 preferably proceeds to 114 of FIG. 5 where the next customer communication connection may be awaited.

Although the disclosed embodiments have been described in detail, it should be understood that various changes, substitutions and alterations can be made to the embodiments without departing from their spirit and scope.

1. A method for provisioning user support in a call-center environment, comprising:
maintaining a plurality of selectable user interface (U/I) models, the U/I models adapted to assist a user in performing a desired transaction;
initiating, in response to a user connection, a current U/I model based on at least one aspect of the user connection;
requesting user selection of a transaction to be performed in accordance with the current U/I model;
monitoring user responsiveness during the user connection;
determining, based on a next node of the selected transaction and at least one aspect of monitored user responsiveness, whether an alternative U/I model is more likely than the current U/I model to elicit effective user responsiveness to the next node;
replacing the current U/I model with a selected alternative U/I model in response to a determination of a preference for the selected alternative U/I model;
activating, after replacement with the selected alternative U/I model, the currently preferred U/I model;
prompting the user as to performance of the next node of the selected transaction in accordance with the current U/I model;
repeating the determining, replacing, activating and prompting steps so long as the selected transaction requires completion of an additional node;
summarizing information gathered during performance of the selected transaction;
requesting user verification of the summarized information;
soliciting any unverified information from the user;
repeating the summarizing, requesting and soliciting steps until there remains no unverified information;
submitting at least one aspect of monitored user responsiveness to a U/I model update system;
evaluating, by the U/I model update system, whether the monitored user responsiveness warrants updating one or more of the plurality of selectable U/I models; and
updating, in accordance with the evaluating step, one or more of the plurality of selectable U/I models.

2. A system for providing user support, comprising:
at least one processor;
a memory operably coupled to the at least one processor;
at least one storage device operably coupled to the processor and the memory, the storage device operable to maintain a plurality of user interface (U/I) models;
a communication interface operably coupled to the processor and the memory, the communication interface operable to communicate information to and from at least one user; and
a program of instructions storable in the memory and executable by the processor, the program of instructions operable to select a current U/I model from the plurality of U/I models based on at least one characteristic of a communication connection, query the user for selection of a transaction to be performed in accordance with the current U/I model, observe at least one of a user response to the query, re-select the current U/I model if the at least one user response characteristic fails to meet an efficacy standard, prompt the user in furtherance of the selected transaction in accordance with the current U/I model and repeat the observe, re-select and prompt operations until the user communication connection is released.

3. The system of claim 2, further comprising the program of instructions operable to update one or more U/I models based on observed user responses.

4. The system of claim 2, further comprising the program of instructions operable to perform a U/I model update upon completion of at least one node of the selected transaction.

5. The system of claim 2, further comprising the program of instructions operable to predict the U/I likely to be most effective in eliciting a desired user response

6. The system of claim 2, further comprising the program of instructions operable to present a transaction summary to the user upon completing at least one node of the selected transaction

7. The system of claim 2, further comprising the program of instructions operable to present motivational prompts to elicit desired user responsiveness.

8. The system of claim 2, further comprising the program of instructions operable to verify user entries after completion of at least one node of the selected transaction.

9. The system of claim 2, further comprising the program of instructions operable to verify user entries meeting a predefined measure of complexity.

10. The system of claim 2, further comprising the program of instructions operable to repeat the observe, re-select and prompt operations at each node of the selected transaction.

11. The system of claim 2, further comprising the program of instructions operable to obtain information required to complete at least a portion of the selected transaction from the user communication connection.

12. A computer readable medium embodying a program of instructions, the program of instructions implementing a method for guiding a user through one or more nodes of a transaction, the program of instructions operable to:
receive a user request for a desired transaction;
select a user interface (U/I) model likely to effect completion of a next stage of the requested transaction;
prompt the user, in accordance with the selected U/I model, through the next stage of the requested transaction; and
repeat the select and prompt operations for each stage required by the requested transaction.

13. The computer readable medium of claim 12, further comprising the program of instructions operable to select an initial U/I model based on at least one characteristic of a communication connection with the user.

14. The computer readable medium of claim 12, further comprising the program of instructions operable to select the U/I model likely to effect completion of the next stage of the requested transaction from a library of U/I models.

15. The computer readable medium of claim 12, further comprising the program of instructions operable to modify a U/I model based on one or more aspects of completing the requested transaction.

16. The computer readable medium of claim 12, further comprising the program of instructions operable to summarize information gathered through at least one stage of the requested transaction.

17. The computer readable medium of claim 12, further comprising the program of instructions operable to suggest benefits to the user of user compliance with the instructions directed to completing a stage of the requested transaction.

18. The computer readable medium of claim 12, further comprising the program of instructions operable to gather information required to complete the requested transaction from a communication connection with the user.

19. The computer readable medium of claim 12, further comprising the program of instructions operable to adapt the selected U/I model to conform with at least one identified aspect of the requested transaction.

20. The computer readable medium of claim 12, further comprising the program of instructions operable to summarize and present for user confirmation, information collected through one or more stages of the requested transaction.
